(19) United States
(12) Patent Application Publication
(10) Pub. No.: US 2022/0407637 A1
(43) Pub. Date: Dec. 22, 2022

(54) HARQ-ACK PROCESSING METHOD AND APPARATUS, COMMUNICATION DEVICE AND STORAGE MEDIUM

(71) Applicant: BEIJING XIAOMI MOBILE SOFTWARE CO., LTD., Beijing (CN)

(72) Inventor: Mingju LI, Beijing (CN)

(73) Assignee: BEIJING XIAOMI MOBILE SOFTWARE CO., LTD., Beijing (CN)

(21) Appl. No.: 17/774,832

(22) PCT Filed: Nov. 6, 2019
(86) PCT No.: PCT/CN2019/116086

§ 371 Date: May 5, 2022

(51) Int. Cl. H04L 1/18; H04L 5/00; H04W 72/04

(52) U.S. Cl. CPC H04L 1/1887; H04L 5/0055; H04W 72/042; H04L 1/1812

(57) ABSTRACT

A method and device for processing hybrid automatic repeat request-acknowledgement (HARQ-ACK), a communication device and a storage medium are provided. The method includes: transmitting configuration signaling for transmitting HARQ-ACK over a channel on unlicensed spectrum by using a one-shot HARQ-ACK mechanism; and transmitting downlink control information (DCI) for scheduling a physical downlink shared channel (PDSCH) resource. Further, in response to triggering the one-shot HARQ-ACK mechanism to transmit the HARQ-ACK, it is determined that the DCI includes a time domain offset-information field carrying a first value that indicates an offset between a time slot of a physical uplink control channel (PUCCH) resource to carry the HARQ-ACK and a time slot of the PDSCH resource.

### CROSS-REFERENCE TO RELATED APPLICATIONS

The present application is a U.S. National Stage of International Application No. PCT/CN2019/116086 filed on Nov. 6, 2019, the entire contents of which are incorporated herein by reference for all purposes.

### TECHNICAL FIELD

The present disclosure relates but is not limited to the field of wireless communication, and particularly, to a method and device for processing hybrid automatic repeat request-acknowledgement (HARQ-ACK), a communication device and a storage medium.

### BACKGROUND

In the fifth generation (5G) New Radio (NR), when a base station schedules a physical downlink shared channel (PDSCH) resource (configured as a communication resource for PDSCH), it needs to indicate a resource for transmitting HARO-ACK corresponding to data transmitted by the PDSCH resource.

A one-shot HARQ-ACK mechanism is proposed in the 5G NR unlicensed (NR-U) channel to indicate feeding back HARQ-ACKs of all HARQ processes at a time. If a base station configures the one-shot HARQ-ACK mechanism for a user equipment (UE), each time when the UE feeds back HARQ-ACK, the UE shall feed back HARQ-ACKs of all HARQ processes (no matter the PDSCH resource corresponding to the HARQ-ACK process is scheduled or not) at a time.

### SUMMARY

The present disclosure provides a method and device for processing HARQ-ACK, a communication device and a storage medium.

A first aspect of the present disclosure provides a method for processing HARQ-ACK transmission, which is applied in a base station, including: transmitting configuration signaling for transmitting HARQ-ACK over a channel on unlicensed spectrum by using a one-shot HARQ-ACK mechanism; and transmitting downlink control information (DCI) for scheduling a PDSCH resource.

Further, in response to triggering the one-shot HARQ-ACK mechanism to transmit the HARQ-ACK, it is determined that the DCI includes a time domain offset-information field carrying a first value, and the first value indicates an offset between a time slot of a physical uplink control channel (PUCCH) resource to carry the HARQ-ACK and a time slot of the PDSCH resource.

A second aspect of the present disclosure provides a method for triggering HARQ-ACK, which is applied in a UE, including: receiving configuration signaling for transmitting HARQ-ACK over a channel on unlicensed spectrum by using a one-shot HARQ-ACK mechanism; receiving DCI for scheduling a PDSCH resource over the channel on unlicensed spectrum; and transmitting HARQ-ACKs of all HARQ processes based on the one-shot HARQ-ACK mechanism in response to determining that a time domain offset-information field included in the DCI carries a first value.

A third aspect of embodiments of the present disclosure provides a communication device including a transceiver, a memory, and a processor which is respectively connected to the transceiver and the memory and configured to control the transceiver to transmit and receive wireless signals and implement the method according to the first aspect by executing computer-executable instructions stored in the memory.

A fourth aspect of the present disclosure provides a computer-readable non-transitory storage medium having computer-executable instructions stored thereon that, when being executed by a processor implement the method according to the first aspect.

A fifth aspect of the present disclosure provides a device for triggering HARQ-ACK, which is applied in a base station, including a processor and a memory storing instructions executable by the processor. Further, the processor is configured to execute the instructions to implement acts according to the first aspect.

A sixth aspect of the present disclosure provides a device for triggering HARQ-ACK which is applied in a UE, including a processor and a memory storing instructions executable by the processor. Further, the processor is configured to execute the instructions to implement the method according to the second aspect.

A seventh aspect of the present disclosure provides a communication device, including a transceiver, a memory and a processor that is respectively connected to the transceiver and the memory and configured to control the transceiver to transmit and receive wireless signals and implement the method for processing HARQ-ACK according to the second aspect by executing computer-executable instructions stored in the memory.

An eight aspect of the present disclosure provides a computer-readable non-transitory storage medium having computer-executable instructions stored thereon that, when being executed by a processor, implement the method for processing HARQ-ACK according to the second aspect.

### BRIEF DESCRIPTION OF THE DRAWINGS

FIG. 1 is a schematic structural diagram of a wireless communication system according to an embodiment of the present disclosure;

FIG. 2 is a schematic flowchart of a method for processing HARQ-ACK according to an embodiment of the present disclosure;

FIG. 3 is a schematic flowchart of a method for processing HARQ-ACK according to an embodiment of the present disclosure;

FIG. 4 is a schematic flowchart of a method for processing HARQ-ACK according to an embodiment of the present disclosure;

FIG. 5 is a schematic structural diagram of a device for processing HARQ-ACK according to an embodiment of the present disclosure;

FIG. 6 is a schematic structural diagram of a device for processing HARQ-ACK according to an embodiment of the present disclosure;

FIG. 7 is a schematic structural diagram of a UE according to an embodiment of the present disclosure; and

FIG. 8 is a schematic structural diagram of a base station according to an embodiment of the present disclosure.

### DETAILED DESCRIPTION

Embodiments will be described in detail herein, examples of which are illustrated in the accompanying drawings. When the following description is made with reference to the drawings, the same numerals in different drawings refer to the same or similar elements unless otherwise indicated. The implementations described in the embodiments below are not intended to represent all implementations of the embodiments of the present disclosure. Rather, they are merely examples of devices and methods according to some aspects of the embodiments of the present disclosure as recited in the appended claims.

The terminology used in the embodiments of the present disclosure is for the purpose of describing particular embodiments only and is not intended to limit the embodiments of the present disclosure. As used in the embodiments of the present disclosure and the appended claims, the singular forms “a,” “the,” and “the” are intended to include the plural forms as well, unless the context clearly dictates otherwise. It will also be understood that the term “and/or” as used herein refers to and includes any and all possible combinations of one or more of the associated listed items.

It should be understood that although the terms first, second, third and the like may be used in the embodiments of the present disclosure to describe various pieces of information, such information should not be limited by these terms. These terms are only used to distinguish the same type of information from each other. For example, first information may also be referred to as second information, and similarly, the second information may also be referred to as the first information, without departing from the scope of the embodiments of the present disclosure. Depending on the context, the word “if” as used herein may be interpreted as “at the time of” or “when” or “in response to determining.”

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

FIG. 1 shows a schematic structural diagram of a wireless communication system according to an embodiment of the present disclosure. As shown in FIG. 1, the wireless communication system is a communication system based on cellular mobile communication technology, and may include a plurality of UEs 11 and a plurality of base stations 12.

The UE 11 may be a device that provides voice and/or data connectivity to a user. The UE 11 may communicate with one or more core networks via radio access network (RAN). The UE 11 may be an IoT UE such as a sensor device, a mobile phone (or “cellular” phone), and may be a computer having the IoT UE, which, for example, may be a stationary, portable, pocket-sized, hand-held, computer-built-in, or vehicle-mounted device. For example, the UE 11 may be a station (STA), subscriber unit, subscriber station, mobile station (mobile station), mobile, remote station, access point, remote terminal, access terminal, user terminal, user agent, user device, or user equipment (UE). Alternatively, the UE 11 may also be a device of an unmanned aerial vehicle. Alternatively, the UE 11 may also be an in-vehicle device, for example, a trip computer with a wireless communication function, or a wireless communication device connected to an external trip computer. Alternatively, the UE 11 may also be a roadside device, for example, may be a streetlight, a signal light, or other roadside device having a wireless communication function.

The base station 12 may be a network-side device in a wireless communication system. The wireless communication system may be a 5G system, also known as a new radio (NR) system or a 5G NR system. Alternatively, the wireless communication system may be a system supporting new radio unlicensed spectrum communication (NR-U, New Radio-Unlicense). Alternatively, the wireless communication system may be a next-generation system of the 5G system. The access network in the 5G system may be called NG-RAN (New Generation-Radio Access Network).

The base station 12 may be a base station (gNB) that adopts a centralized distributed architecture in the 5G system. When adopting the centralized distributed architecture, the base station 12 usually includes a central unit (CU) and at least two distributed units (DUs). The central unit is provided with a protocol stack of a packet data convergence protocol (PDCP) layer, a radio link control (RLC) layer, and a medium access control (MAC) layer. The distributed unit is provided with a physical (PHY) layer protocol stack. The specific implementation manner of the base station 12 is not limited in the embodiments of the present disclosure.

A wireless connection may be established between the base station 12 and the UE 11 through a wireless air interface. In different embodiments, the wireless air interface is a wireless air interface based on the fifth generation mobile communication network technology (5G) standard, for example, the wireless air interface is a new radio; or, the wireless air interface may also be a wireless air interface of a 5G-based next generation mobile communication network technology standard.

In some embodiments, an E2E (end-to-end) connection may also be established between the UEs 11. In some embodiments, the above wireless communication system may further include a network management device 13.

The plurality of base stations 12 are respectively connected to the network management device 13. The network management device 13 may be a core network device in a wireless communication system, for example, the network management device 13 may be a mobility management entity (MME) in an evolved packet core network (EPC). Alternatively, the network management device may also be other core network devices, such as a serving gateway (SGW), public data network gateway (PGW), policy and charging rules function unit (PCRF), home subscriber server (HSS) or the like. The implementation of the network management device 13 is not limited in the embodiments of the present disclosure.

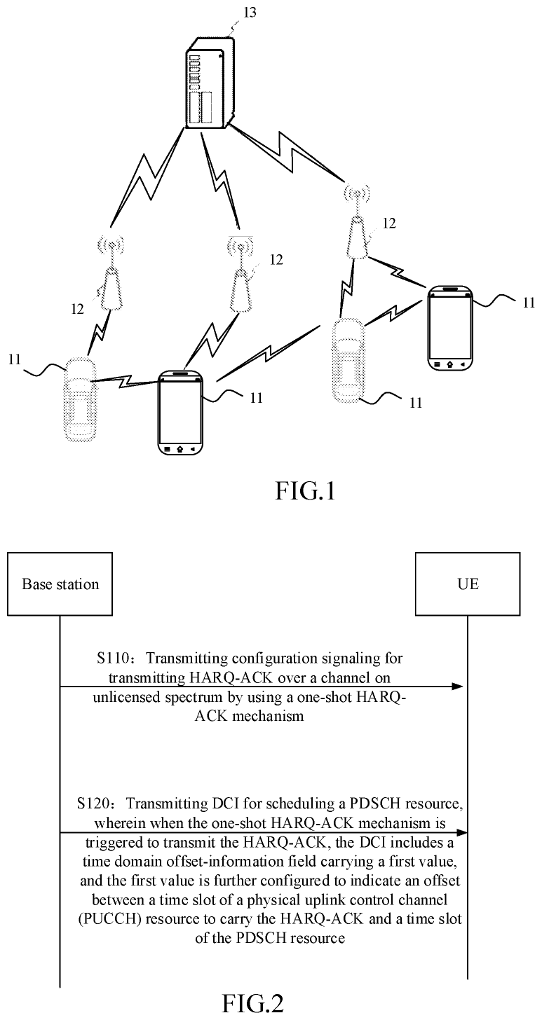

As shown in FIG. 2, an embodiment provides a method for triggering HARQ-ACK, which is applied in a base station, including:

S110, transmitting configuration signaling for transmitting HARQ-ACK over a channel on unlicensed spectrum by using a one-shot HARQ-ACK mechanism; and

S120, transmitting DCI for scheduling a PDSCH resource.

When the one-shot HARQ-ACK mechanism is triggered to transmit the HARQ-ACK, the DCI includes a time domain offset-information field carrying a first value, and the first value is further configured to indicate an offset between a time slot of a physical uplink control channel (PUCCH) resource to carry the HARQ-ACK and a time slot of the PDSCH resource.

On the channel on unlicensed spectrum, if the one-shot HARQ-ACK mechanism is used to transmit the HARQ-ACK, a UE will transmit HARQ-ACKs corresponding to all HARQ processes to a base station at a time. For example, if the number of HARQ processes is 16, when the one-shot HARQ-ACK is used to transmit HARQ-ACK, the UE will transmit HARQ-ACKs of the 16 HARQ processes to the base station at a time, and the base station will receive 16 HARQ-ACKs transmitted by the UE at a time. For example, if the number of HARQ processes is 8, when the one-shot HARQ-ACK is used to transmit HARQ-ACK, the UE will transmit HARQ-ACKs of the 8 HARQ processes to the base station at a time, and the base station will receive 8 HARQ-ACKs transmitted by the UE at a time.

The HARQ-ACK may include: ACK and NACK. The ACK indicates successful data reception, and the NACK indicates unsuccessful data reception.

The HARQ-ACK is feedback information of the data sent by the PDSCH resource.

The configuration signaling may be transmitted by the base station through higher layer signaling. The high layer signaling includes but is not limited to radio resource control (RRC) signaling.

The configuration signaling may be transmitted before the DCI, or may be transmitted simultaneously with the DCI.

The DCI carries a scheduling instruction of PDSCH resource, and the scheduling instruction schedules the PDSCH resource for the UE to transmit data.

The DCI scheduling the PDSCH resource includes a kl information domain and a PRI-information domain. The kl information domain is the aforementioned time domain offset-information field. The kl value is an arbitrary value carried in the time domain offset-information field. The kl value carried in the kl information domain indicates an interval between a time slot used by the HARQ-ACK and a time slot where the PDSCH resource is located. The PRI-information domain indicates identification (ID) of the PUCCH resource that carries the HARQ-ACK. The time slot in which the PUCCH resource carrying the HARQ-ACK is located may be determined according to the indication of the kl value in the DCI. An index of a PUCCH resource set, that is, ID of the PUCCH resource set, may be determined according to the number of bits of the HARQ-ACK that needs to be fed back. The number of HARQ-ACK bits is common information known to both the base station and the UE, and thus does not need to be indicated in the DCI. The information domain in the DCI may be used to determine the index of the PUCCH resource used in the PUCCH resource set, that is, the ID of the PUCCH resource. In some other cases, when determining the PUCCH resource for transmitting HARQ-ACK, the ID of the PUCCH resource may be determined in conjunction with the control channel resource carrying the DCI.

In some embodiments, when the using of the one-shot HARQ-ACK mechanism to transmit HARQ-ACK is not triggered, the DCI includes the time domain offset-information field carrying a second value. The second value different from the first value.

In some embodiments, when the using of the one-shot HARQ-ACK mechanism to transmit HARQ-ACK is not triggered, the DCI may not carry the time domain offset-information field, or, the DCI carries the time domain offset-information field, but the time domain offset-information field does not carry any content.

However, in an embodiment of the present disclosure, when the using of the one-shot HARQ-ACK mechanism to transmit HARQ-ACK is not triggered, the time domain offset-information field may be also carried in the DCI, which is different from that the using of the one-shot HARQ-ACK mechanism to transmit HARQ is triggered in that the time domain offset-information field carries the second value. In this way, compared with that the time domain offset-information field is not carried, the format of the DCI may be maintained unchanged in both triggering and non-triggering situations, thereby reducing the difficulty of blind decoding of the DCI by the UE caused by the change of the DCI format; and compared with that the time domain offset-information field does not carry any content, the phenomenon that the UE mistakenly regards that the decoding is wrong is reduced. When the present disclosure does not trigger the using of the one-shot HARQ-ACK mechanism to transmit HARQ-ACK, the DCI also carries the time-domain offset-information field, and the time domain offset-information field carries information content, which has improved compatibility with the prior art.

It should be noted that the first value may be from a first set, the second value may be from a second set, and the first set includes a larger number of alternative values than that of alternative values included in the second set.

For example, the time domain offset-information field is 3 bits, these 3 bits have 8 values from 0 to 7, one of the 8 values is divided into the second set, and the remaining 7 values are divided into the first set, so that the requirement that the first value indicates different time slot offsets is satisfied.

In some embodiments, the DCI further includes a PRI-information domain, and the PRI information domain is configured to indicate a resource identification of the PUCCH resource carrying the HARQ-ACK.

The resource identification may at least be configured to determine a resource set that carries the HARQ-ACK, and then in combination with the time slot offset indicated by kl, a corresponding PUCCH resource may be selected from the resource set to transmit the HARQ-ACK.

In some embodiments, the method further includes:

determining whether to trigger the one-shot HARQ-ACK mechanism to transmit the HARQ-ACK.

The determining whether to trigger the one-shot HARQ-ACK mechanism to transmit the HARQ-ACK may include:

when there is no data to be transmitted in a downlink data buffer, determining to trigger the one-shot HARQ-ACK mechanism; or

when transmission of data corresponding to all HARQ processes is completed, determining to trigger the one-shot HARQ-ACK mechanism.

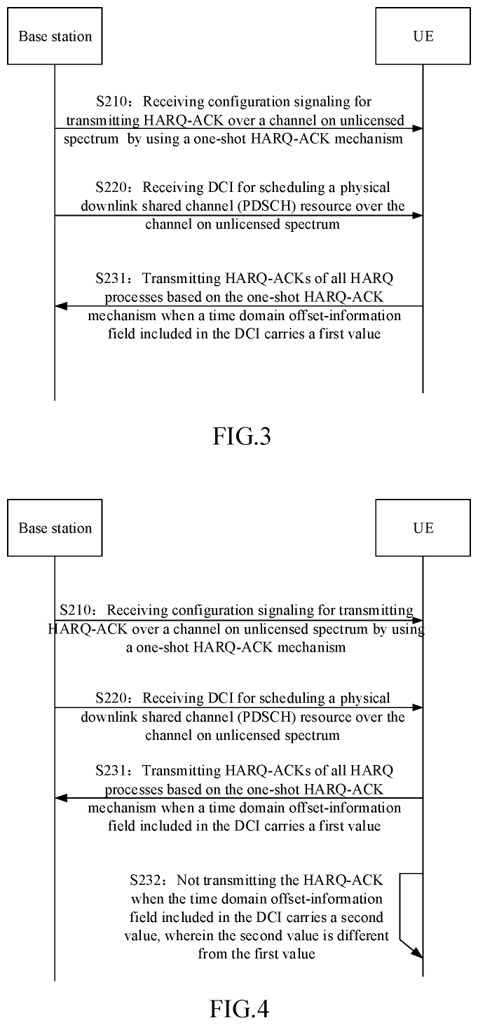

As shown in FIG. 3, an embodiment of the present disclosure further provides a method for triggering HARQ-ACK, which is applied in a UE, including:

S210, receiving configuration signaling for transmitting HARQ-ACK over a channel on unlicensed spectrum by using a one-shot HARQ-ACK mechanism;

S220, receiving DCI for scheduling a physical downlink shared channel (PDSCH) resource over the channel on unlicensed spectrum; and

S231, transmitting HARQ-ACKs of all HARQ processes based on the one-shot HARQ-ACK mechanism in response to that a time domain offset-information field included in the DCI carries a first value.

In an embodiment of the present disclosure, the UE may receive configuration signaling on the channel on unlicensed spectrum, which configures the UE to transmit HARQ-ACK using the one-shot HARQ-ACK mechanism.

After receiving the configuration signaling, the UE when transmitting HARQ-ACK may generate ACK or NACK for the reception status of data corresponding to all HARQ-ACK processes at a time, and form a HARQ-ACK codebook and feed back the same at a time.

One HARQ-ACK may correspond to 1 bit of feedback information. In this way, when N HARQ processes are scheduled for data transmission, and the UE transmits HARQ-ACK based on the one-shot HARQ-ACK mechanism, HARQ-ACKs of N bits are transmitted at a time.

In some embodiments, the ordering of the N bits is based on the size of the HARQ process number. For example, the feedback information corresponding to the HARQ process with a smaller HARQ process number is arranged in the high order of the N bits, and the feedback information corresponding to the HARQ process with a larger HARQ process number is arranged in the low order.

As shown in FIG. 4, the method further includes:

S232, not transmitting the HARQ-ACK in response to that the time domain offset-information field included in the DCI carries a second value, the second value being different from the first value.

In the present disclosure, according to the value carried in the time domain offset-information field, whether the base station triggers the UE to use the one-shot HARQ-ACK mechanism to transmit HARQ-ACK may be determined. In addition to indicate that the using of the one-shot HARQ-ACK mechanism to transmit the HARQ-ACK is triggered, the first value is further configured to indicate a time slot offset between the PUCCH resource used by the UE to transmit the HARQ-ACK and the physical downlink shared channel (PDSCH) resource. The time slot offset here is the number of time slots between the PDSCH resource and the PUCCH resource. Generally, the PDSCH resource is located before the PUCCH resource that carries the HARQ-ACK of the data of the PDSCH resource in the time domain.

In some embodiments, the method further includes:

determining a resource position of a physical uplink control channel (PUCCH) resource carrying the HARQ-ACK according to a PUCCH resource identification carried by a physical uplink control channel resource indicator (PRI)-information domain included in the DCI and the first value, the resource identification being configured to indicate the PUCCH resource that carries the HARQ-ACK, and the first value being configured to indicate an offset between a time slot of the PUCCH resource to carry the HARQ-ACK and a time slot of the PDSCH resource.

As shown in FIG. 5, an embodiment provides a device for triggering HARQ-ACK, which is applied in a base station, including:

a first transmitting module 510, configured to transmit configuration signaling for transmitting HARQ-ACK over a channel on unlicensed spectrum by using a one-shot HARQ-ACK mechanism; and

a second transmitting module 520, configured to transmit downlink control information (DCI) for a PDSCH resource, wherein when the one-shot HARQ-ACK mechanism is triggered to transmit the HARQ-ACK, the DCI includes a time domain offset-information field carrying a first value, and the first value is further configured to indicate an offset between a time slot of a physical uplink control channel (PUCCH) resource to carry the HARQ-ACK and a time slot of the PDSCH resource.

In some embodiments, the first transmitting module 510 and the second transmitting module 520 may be program modules, and after the program modules are executed by a processor, the transmitting of the configuration signaling and DCI may be implemented.

In other embodiments, the first transmitting module 510 and the second transmitting module 520 may be software-hardware combination modules. The software-hardware combination module includes but is not limited to a programmable array, and the programmable array includes but is not limited to a field programmable array or a complex programmable array.

In still other embodiments, the first transmitting module 510 and the second transmitting module 520 may include hardware-only modules, and the hardware-only module includes but is not limited to an application specific integrated circuit.

Based on the above solution, when the one-shot HARQ-ACK mechanism is not triggered to transmit the HARQ-ACK, the DCI includes the time domain offset-information field carrying a second value, and the second value is different from the first value.

Based on the above solution, the DCI further includes a physical uplink control channel resource indicator (PRI)-information domain, and the PRI-information domain is configured to indicate a resource identification of the PUCCH resource carrying the HARQ-ACK.

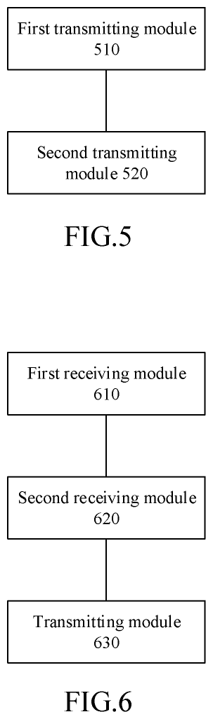

As shown in FIG. 6, an embodiment provides a device for triggering HARQ-ACK, which is applied in an UE, comprising:

a first receiving module 610, configured to receive configuration signaling for transmitting HARQ-ACK over a channel on unlicensed spectrum by using a one-shot HARQ-ACK mechanism;

a second receiving module 620, configured to receive downlink control information (DCI) for scheduling a physical downlink shared channel (PDSCH) resource over the channel on unlicensed spectrum; and

a transmitting module 630, configured to transmit HARQ-ACKs of all HARQ processes based on the one-shot HARQ-ACK mechanism in response to that a time domain offset-information field included in the DCI carries a first value.

In some embodiments, the first receiving module 610, the second receiving module 620 and the transmitting module 630 may be program modules, and after the program modules are executed by a processor, the receiving of the configuration signaling and DCI and the transmitting of the HARQ-ACK may be implemented.

In other embodiments, the first receiving module 610, the second receiving module 620 and the transmitting module 630 may be software-hardware combination modules. The software-hardware combination module includes but is not limited to a programmable array, and the programmable array includes but is not limited to a field programmable array or a complex programmable array.

In still other embodiments, the first receiving module 610, the second receiving module 620 and the transmitting module 630 may comprise hardware-only modules, and the hardware-only module includes but is not limited to an application specific integrated circuit.

Based on the above solution, the transmitting module is further configured to not transmit the HARQ-ACK in response to that the time domain offset-information field included in the DCI carries a second value. The second value is different from the first value.

Based on the above solution, the device further includes:

a determining module, configured to determine a resource position of a physical uplink control channel (PUCCH) resource carrying the HARQ-ACK according to a PUCCH resource identification carried by a physical uplink control channel resource indicator (PRI)-information domain included in the DCI and the first value, wherein the resource identification is configured to indicate the PUCCH resource that carries the HARQ-ACK, and the first value is configured to indicate an offset between a time slot of the PUCCH resource to carry the HARQ-ACK and a time slot of the PDSCH resource.

An embodiment of the present disclosure provides a communication device, including:

a transceiver;

a memory; and

a processor, respectively connected to the transceiver and the memory, and configured to control the transceiver to transmit and receive wireless signals and implement the method for processing HARO-ACK in any of the above solutions, for example, perform at least one of the methods shown in FIGS. 2 to 4, by executing computer-executable instructions stored in the memory.

An embodiment of the present disclosure provides a computer-readable non-transitory storage medium having computer-executable instructions stored thereon that, when being executed by a processor, implement the method for processing HARO-ACK in any of the above solutions, for example, perform at least one of the methods shown in FIGS. 2 to 4.

In the technical solution provided by the embodiments of the present disclosure, if a one-shot HARQ-ACK mechanism is configured for a UE to transmit HARQ-ACK over an unlicensed channel, a time domain offset-information domain may be carried in DCI carrying a scheduling instruction of PDSCH resource. When it is determined to trigger the use of the one-shot HARQ-ACK mechanism, the time domain offset-information domain is configured to carry a first value, and the first value may be a value pre-known by both a base station and the UE and triggering the use of the one-shot HARQ-ACK mechanism for HARQ-ACK transmission. In this way, the time domain offset-information domain of the DCI with an existing format may be used to trigger the UE to use the one-time HARQ-ACK mechanism for HARQ-ACK transmission without changing the DCI format. The first value carried in the time domain offset-information domain is also used to indicate a time-domain offset between a scheduled PDSCH resource and a PUCCH resource that transmits the HARQ-ACK of the data transmitted by the PDSCH resource. Therefore, the first value carried in the time domain offset-information domain has two functions, thereby realizing function reuse, which, in comparison with a case where each function is indicated by one information domain, reduces the number of information domains and thus reduces signaling overhead caused by a plurality of information domains.

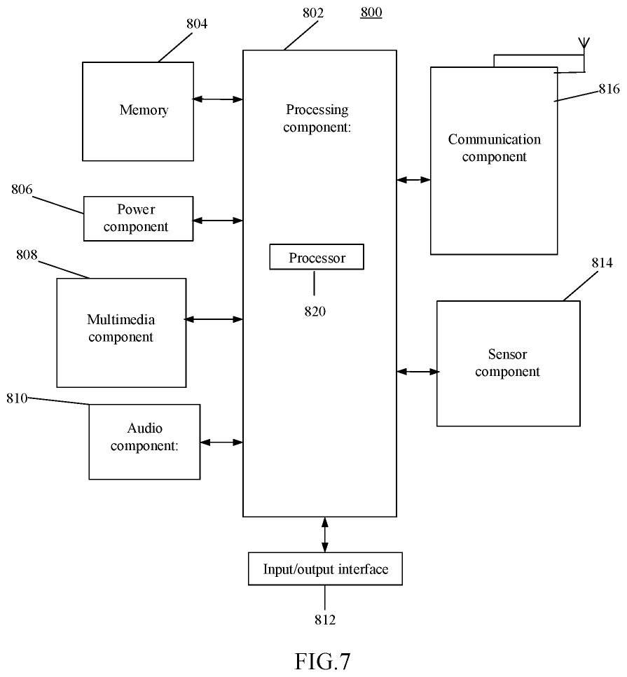

FIG. 7 shows a UE according to an embodiment. The UE may be a mobile phone, a computer, a digital broadcasting UE, a messaging device, a game console, a tablet device, a medical device, a fitness device, a personal digital assistant, or the like.

Referring to FIG. 7, the UE 800 may include one or more of a processing component 802, a memory 804, a power component 806, a multimedia component 808, an audio component 810, an input/output (I/O) interface 812, a sensor component 814, and a communication component 816.

The processing component 802 generally controls the overall operations of the UE 800, such as operations associated with display, telephone calls, data communications, camera operations, and recording operations. The processing component 802 may include one or more processors 820 to execute instructions to complete all or part of the steps of the foregoing method. In addition, the processing component 802 may include one or more modules to facilitate interaction between the processing component 802 and other components. For example, the processing component 802 may include a multimedia module to facilitate the interaction between the multimedia component 808 and the processing component 802.

The memory 804 is configured to store various types of data to support the operation at the UE 800. Examples of these data include instructions for any application or method operating on the UE 800, contact data, phone book data, messages, pictures, videos and the like. The memory 804 may be implemented by any type of volatile or non-volatile storage device or a combination thereof, such as static random access memory (SRAM), electrically erasable programmable read-only memory (EEPROM), erasable and programmable read-only memory (EPROM), programmable read-only memory (PROM), read-only memory (ROM), magnetic memory, flash memory, magnetic disk or optical disk.

The power component 806 provides power to various components of the UE 800. The power component 806 may include a power management system, one or more power supplies, and other components associated with generating, managing, and distributing power for the UE 800.

The multimedia component 808 includes a screen that provides an output interface between the UE 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, sliding, and gestures on the touch panel. The touch sensor may not only sense the boundary of the touch or slide action, but also detect the duration and pressure related to the touch or slide operation. In some embodiments, the multimedia component 808 includes a front camera and/or a rear camera. When the UE 800 is in an operation mode, such as a shooting mode or a video mode, the front camera and/or the rear camera can receive external multimedia data. Each front camera and rear camera may be a fixed optical lens system or have focal length and optical zoom capabilities.

The audio component 810 is configured to output and/or input audio signals. For example, the audio component 810 includes a microphone (MIC), and when the UE 800 is in an operation mode, such as a call mode, a recording mode, and a voice recognition mode, the microphone is configured to receive an external audio signal. The received audio signal can be further stored in the memory 804 or sent via the communication component 816. In some embodiments, the audio component 810 further includes a speaker for outputting audio signals.

The I/O interface 812 provides an interface between the processing component 802 and a peripheral interface module. The above-mentioned peripheral interface module may be a keyboard, a click wheel, a button, and the like. These buttons may include but are not limited to home button, volume button, start button, and lock button.

The sensor component 814 includes one or more sensors for providing the UE 800 with various aspects of state evaluation. For example, the sensor component 814 can detect the on/off status of the UE 800 and the relative positioning of components. For example, the component is a display and keypad of the UE 800. The sensor component 814 can also detect the position change of the UE 800 or a component of the UE 800, the presence or absence of contact between the user and the UE 800, the orientation or acceleration/deceleration of the UE 800, and the temperature change of the UE 800. The sensor component 814 may include a proximity sensor configured to detect the presence of nearby objects when there is no physical contact. The sensor component 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the UE 800 and other devices. The UE 800 can access a wireless network based on a communication standard, such as WiFi, 2G, or 3G, or a combination thereof. In an embodiment, the communication component 816 receives a broadcast signal or broadcast related information from an external broadcast management system via a broadcast channel. In an embodiment, the communication component 816 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment, the UE 800 may be implemented by one or more of application specific integrated circuit (ASIC), digital signal processor (DSP), digital signal processing device (DSPD), programmable logic devices (PLD), field programmable gate array (FPGA), controller, microcontroller, microprocessor, or other electronic components, to perform the above-mentioned methods.

An embodiment also provides a non-transitory computer-readable storage medium including instructions, such as the memory 804 including instructions, and the instructions may be executed by the processor 820 of the UE 800 to complete the foregoing method. For example, the non-transitory computer-readable storage medium may be ROM, random access memory (RAM), CD-ROM, magnetic tape, floppy disk, optical data storage device and the like.

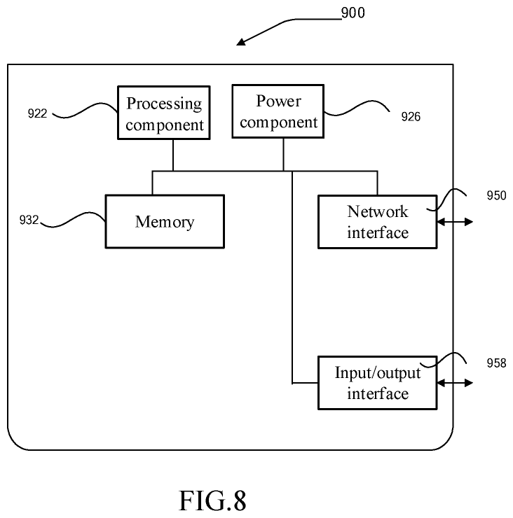

FIG. 8 is a schematic diagram of a base station. Referring to FIG. 8, the base station 900 includes a processing component 922 which further includes one or more processors, and a memory resource which is represented by a memory 932 and is configured for storing instructions such as application programs executable by the processing component 922. The application program stored in the memory 932 may include one or more modules each corresponding to a set of instructions. Furthermore, the processing component 922 is configured to execute instructions to perform the PDCCH listening method shown in FIG. 4 and/or FIG. 5.

The base station 900 may also include a power component 926 configured to perform power management of the base station 900, a wired or wireless network interface 950 configured to connect the base station 900 to a network, and an input/output (I/O) interface 958. The base station 900 may operate based on an operating system stored in memory 932, such as Windows Server™, Mac OS X™, Unix™, Linux™, Free BSD™ or the like.

Those skilled in the art may easily conceive of other embodiments of the present disclosure upon consideration of the specification and practice of the invention disclosed herein. The present disclosure is intended to cover any variations, uses, or adaptations of the present disclosure that follow the general principles of the present disclosure and include the common general knowledge or conventional technical means in the technical field not disclosed by the present disclosure. The specification and embodiments are to be regarded as exemplary only, with the true scope and spirit of the present disclosure being indicated by the following claims.

It is to be understood that the present disclosure is not limited to the precise structures described above and illustrated in the accompanying drawings, and that various modifications and changes may be made without departing from the scope thereof. The scope of the present disclosure is limited only by the appended claims.

1. A method for triggering hybrid automatic repeat request-acknowledgement (HARQ-ACK), comprising:
transmitting, by a base station, configuration signaling for transmitting HARQ-ACK over a channel on unlicensed spectrum by using a one-shot HARQ-ACK mechanism; and
transmitting, by the base station, downlink control information (DCI) for scheduling a physical downlink shared channel (PDSCH) resource,
wherein in response to triggering the one-shot HARQ-ACK mechanism to transmit the HARQ-ACK, determining that the DCI comprises a time domain offset-information field carrying a first value indicating an offset between a time slot of a physical uplink control channel (PUCCH) resource to carry the HARQ-ACK and a time slot of the PDSCH resource.

2. The method according to claim 1, further comprising:
in response to determining that the one-shot HARQ-ACK mechanism is not triggered to transmit the HARQ-ACK, determining that the DCI comprises the time domain offset-information field carrying a second value that is different from the first value.

3. The method according to claim 1, wherein the DCI further comprises a physical uplink control channel resource indicator (PRI)-information domain, and the PRI-information domain indicates a resource identification of the PUCCH resource carrying the HARQ-ACK.

4. A method for triggering hybrid automatic repeat request-acknowledgement (HARQ-ACK), comprising:
receiving, by a user equipment (UE), configuration signaling for transmitting HARQ-ACK over a channel on unlicensed spectrum by using a one-shot HARQ-ACK mechanism;
receiving, by the UE, downlink control information (DCI) for scheduling a physical downlink shared channel (PDSCH) resource over the channel on unlicensed spectrum; and
transmitting, by the UE, HARQ-ACKs of all HARQ processes based on the one-shot HARQ-ACK mechanism in response to determining that a time domain offset-information field comprised in the DCI carries a first value.

5. The method according to claim 4, further comprising:
determining, by the UE, that the HARQ-ACK is not transmitted in response to determining that the time domain offset-information field comprised in the DCI carries a second value,
wherein the second value is different from the first value.

6. The method according to claim 4, further comprising:
determining, by the UE, a resource position of a physical uplink control channel (PUCCH) resource carrying the HARQ-ACK according to a PUCCH resource identification carried by a physical uplink control channel resource indicator (PRI)-information domain comprised in the DCI and the first value,
wherein the resource identification indicates the PUCCH resource that carries the HARQ-ACK, and the first value indicates an offset between a time slot of the PUCCH resource to carry the HARQ-ACK and a time slot of the PDSCH resource.

7.-12. (canceled)

13. A communication device, comprising:
a transceiver;
a memory; and
a processor, respectively connected to the transceiver and the memory and configured to control the transceiver to transmit and receive wireless signals and implement the method according to claim 1 by executing computer-executable instructions stored in the memory.

14. (canceled)

15. The method according to claim 2, wherein the DCI further comprises a physical uplink control channel resource indicator (PRI)-information domain, and the PRI-information domain indicates a resource identification of the PUCCH resource carrying the HARQ-ACK.

16. The method according to claim 5, further comprising:
determining, by the UE, a resource position of a physical uplink control channel (PUCCH) resource carrying the HARQ-ACK according to a PUCCH resource identification carried by a physical uplink control channel resource indicator (PRI)-information domain comprised in the DCI and the first value,
wherein the resource identification indicates the PUCCH resource that carries the HARQ-ACK, and the first value indicates an offset between a time slot of the PUCCH resource to carry the HARQ-ACK and a time slot of the PDSCH resource.

17. A device for triggering hybrid automatic repeat request-acknowledgement (HARQ-ACK), which is applied in a base station, comprising:
a processor; and
a memory storing instructions executable by the processor,
wherein the processor is configured to execute the instructions to implement:
transmitting configuration signaling for transmitting HARQ-ACK over a channel on unlicensed spectrum by using a one-shot HARQ-ACK mechanism; and
transmitting downlink control information (DCI) for scheduling a physical downlink shared channel (PDSCH) resource,
wherein in response to triggering the one-shot HARQ-ACK mechanism to transmit the HARQ-ACK, determining that the DCI comprises a time domain offset-information field carrying a first value indicating an offset between a time slot of a physical uplink control channel (PUCCH) resource to carry the HARQ-ACK and a time slot of the PDSCH resource.

18. The device according to claim 17, wherein the processor is configured to execute the instructions to further implement: in response to determining that the one-shot HARQ-ACK mechanism is not triggered to transmit the HARQ-ACK, determining that the DCI comprises the time domain offset-information field carrying a second value that is different from the first value.

19. The device according to claim 17, wherein the DCI further comprises a physical uplink control channel resource indicator (PRI)-information domain, and the PRI-information domain indicates a resource identification of the PUCCH resource carrying the HARQ-ACK.

20. The device according to claim 18, wherein the DCI further comprises a physical uplink control channel resource indicator (PRI)-information domain, and the PRI-information domain indicates a resource identification of the PUCCH resource carrying the HARQ-ACK.

21. A device for triggering hybrid automatic repeat request-acknowledgement (HARQ-ACK), which is applied in a user equipment (UE), comprising:
a processor; and
a memory storing instructions executable by the processor,
wherein the processor is configured to execute the instructions to implement the method according to claim 4.

22. The device according to claim 21, wherein the method further comprises:
determining that the HARQ-ACK is not transmitted in response to determining that the time domain offset-information field comprised in the DCI carries a second value,
wherein the second value is different from the first value.

23. The device according to claim 21, wherein the method further comprises:
determining a resource position of a physical uplink control channel (PUCCH) resource carrying the HARQ-ACK according to a PUCCH resource identification carried by a physical uplink control channel resource indicator (PRI)-information domain comprised in the DCI and the first value,
wherein the resource identification indicates the PUCCH resource that carries the HARQ-ACK, and the first value indicates an offset between a time slot of the PUCCH resource to carry the HARQ-ACK and a time slot of the PDSCH resource.

24. The device according to claim 22, wherein the method further comprises:
determining a resource position of a physical uplink control channel (PUCCH) resource carrying the HARQ-ACK according to a PUCCH resource identification carried by a physical uplink control channel resource indicator (PRI)-information domain comprised in the DCI and the first value,
wherein the resource identification indicates the PUCCH resource that carries the HARQ-ACK, and the first value indicates an offset between a time slot of the PUCCH resource to carry the HARQ-ACK and a time slot of the PDSCH resource.

25. A communication device, comprising:
a transceiver;
a memory; and
a processor, respectively connected to the transceiver and the memory and configured to control the transceiver to transmit and receive wireless signals and implement the method according to claim 4 by executing computer-executable instructions stored in the memory.

26. The communication device according to claim 25, wherein the method further comprises:
determining that the HARQ-ACK is not transmitted in response to determining that the time domain offset-information field comprised in the DCI carries a second value,
wherein the second value is different from the first value.

27. The communication device according to claim 25, wherein the method further comprises:
determining a resource position of a physical uplink control channel (PUCCH) resource carrying the HARQ-ACK according to a PUCCH resource identification carried by a physical uplink control channel resource indicator (PRI)-information domain comprised in the DCI and the first value,
wherein the resource identification indicates the PUCCH resource that carries the HARQ-ACK, and the first value indicates an offset between a time slot of the PUCCH resource to carry the HARQ-ACK and a time slot of the PDSCH resource.
